(19) United States
(12) Patent Application Publication
(10) Pub. No.: US 2002/0194052 A1
(43) Pub. Date: Dec. 19, 2002

(54) Method and system for analyzing application needs of an entity

(75) Inventors: Paula F. Delano, South Hero, VT (US); Wendell L. Duggins, Durham, NC (US); Elias Olson, Fresno, CA (US); Cynthia L. Parris, Hollister, CA (US); John L. Trumble, Endicott, NY (US); William A. Westberry, Raleigh, NC (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY (US)

(21) Appl. No.: 09/878,518

(22) Filed: Jun. 11, 2001

(51) Int. Cl. G06F 17/60

(52) U.S. Cl. 705/10

(57) ABSTRACT

A method and system for analyzing application needs on an entity. Specifically, the present invention presents an entity with sets of questions and weighted responses pertaining to the entity's applications. The sets of questions and weighted responses are formulated based upon the entity's business strategy. The entity's responses to the questions are analyzed. Based on the analysis, recommendations regarding the entity's applications are made.

### BACKGROUND OF THE INVENTION

1. Technical Field

The present invention generally relates to a method and system for analyzing application needs of an entity. More particularly, the system and method of the present invention analyze application needs by presenting questions and weighted responses to the entity that are formulated based upon the entity's business strategy.

2. Background Art

In today's accelerated business environment, software application portfolios for business entities are growing at an alarming rate. One reason for such growth is the increased use of the Internet. Specifically, business entities are now seeking to offer their services on-line, which often requires specific software applications. For example, a bank might have several business processes, two of which are: (1) on-line banking; and (2) check processing. The on-line banking process might require several new applications to ensure real-time transmission of data, etc., while the check processing might require basic legacy applications. However, in adding new applications, entities rarely eliminate or modify existing applications. In contrast, entities are increasingly utilizing data warehouses and extract programs. This can result in an application portfolio with multiple applications that perform the same function, and/or applications that conflict with each another. Accordingly, an application portfolio might include several applications that add little or no value.

This problem is even more pronounced when business entities merge, are purchased, or otherwise combine their efforts. In particular, each entity might have its own disjointed application portfolio. When combined, the resulting application portfolio can be both unmanageable and deleterious to good business.

Heretofore, attempts have been made at optimizing application portfolios. However, such attempts fail to optimize an application portfolio based on the particular business entity's business strategy. An entity's business strategy could set forth valuable information (e.g., business objectives and priorities) that would be useful in optimizing its application portfolio. For example, a particular bank's business strategy might indicate that obtaining real-time transaction of data for on-line banking transactions is a top priority. This information could help an evaluator determine which applications are needed and which are superfluous (e.g., which applications limit or prevent real-time data transmission).

In view of the foregoing, there exists a need for a method and system for analyzing application needs of an entity. In particular, a need exists for a method and system for analyzing an entity's application portfolio based on the entity's business strategy.

### SUMMARY OF THE INVENTION

The present invention overcomes the drawbacks of existing methods and systems by providing a method and system for analyzing application needs of an entity. In particular, the present invention analyzes an entity's application portfolio based on the entity's business strategy. To conduct the analysis, a set of questions and weighted responses related to the entity's applications will be formulated based on the entity's business strategy. The entity's responses to the set of questions will then be analyzed, and recommendations for adding, deleting, and/or modifying applications will be made.

According to a first aspect of the present invention, a method for analyzing application needs of an entity is provided. The method comprises the steps of: (1) inventorying a set of entity applications; (2) formulating a set of questions related to an entity application based on a business strategy corresponding to the entity; and (3) receiving entity responses to the set of questions.

According to a second aspect of the present invention, a method for analyzing application needs of an entity is provided. The method comprises the steps of: (1) inventorying a set of entity applications; (2) formulating a set of questions related to an entity application based on a business strategy corresponding to the entity; (3) weighting possible responses to the set of questions based on the business strategy; (4) receiving entity responses to the set of questions; and (5) analyzing the entity responses to make a set of recommendations.

According to a third aspect of the present invention, a method for analyzing application needs of an entity is provided. The method comprises the steps of: (1) inventorying a set of entity applications; (2) formulating a set of questions and possible responses related to an entity application based on a business strategy corresponding to the entity; (3) weighting the possible responses for each question with an assigned value based on the business strategy; (4) receiving entity responses to the set of questions; (5) analyzing values corresponding to the entity responses; and (6) making a set of recommendations based on the analysis.

According to a fourth aspect of the present invention, a system for analyzing application needs of an entity is provided. The system comprises: (1) an inventory system for inventorying entity applications; (2) a query system for providing a set of questions and weighted responses related to an entity application, wherein the set of questions and weighted responses are formulated based on a business strategy corresponding to the entity; and (3) a review system for analyzing entity responses to the set of questions.

According to a fifth aspect of the present invention, a system for analyzing application needs of an entity is provided. The system comprises: (1) an inventory system for inventorying entity applications; (2) a query system for providing a set of questions and weighted responses related to an entity application, wherein the set of questions and weighted responses are formulated based on a business strategy corresponding to the entity; (3) an examination system for receiving entity responses to the set of questions; (4) a review system for analyzing values corresponding to the entity responses; and (5) a recommendation system for making a set of recommendations based on the analyzed values.

According to a sixth aspect of the present invention, a program product stored on a recordable medium for analyzing application needs of an entity is provided. When executed, the program product comprises: (1) an inventory system for inventorying entity applications; (2) a query system for providing a set of questions and weighted responses related to an entity application, wherein the set of questions and weighted responses are formulated based on a business strategy corresponding to the entity; and (3) a review system for analyzing entity responses to the set of questions.

According to a seventh aspect of the present invention, a computer system for analyzing application needs of an entity is provided. The computer system comprises: (1) a processor; (2) a computer system memory; (3) an interface; and (4) a software product stored on the computer system memory and executable by the processor, wherein the software product comprises: (a) an inventory system for inventorying entity applications; (b) a query system for providing a set of questions and weighted responses related to an entity application, wherein the set of questions and weighted responses are formulated based on a business strategy corresponding to the entity; and (c) a review system for analyzing entity responses to the set of questions.

Therefore, the present invention provides a method and system for analyzing application needs of an entity.

### BRIEF DESCRIPTION OF THE DRAWINGS

These and other features and advantages of this invention will be more readily understood from the following detailed description of the various aspects of the invention taken in conjunction with the accompanying drawings in which:

FIG. 1 depicts a computer system having an analysis system, according to the present invention.

FIG. 2 depicts a box diagram of the analysis system of FIG. 1.

FIG. 3 depicts a first exemplary question matrix, according to the present invention.

FIG. 4 depicts a second exemplary question matrix, according to the present invention.

FIG. 5 depicts a third exemplary question matrix, according to the present invention.

FIG. 6 depicts a fourth exemplary question matrix, according to the present invention.

FIG. 7 depicts a flow chart of a first method, according to the present invention.

FIG. 8 depicts a flow chart of a second method, according to the present invention.

FIG. 9 depicts a flow chart of a third method, according to the present invention.

It is noted that the drawings of the invention are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

For convenience, this description will include the following sections:

I. Definitions

II. Overview

III. Computer System

IV. Analysis System

V. Example Matrices

VI. Methods

I. Definitions

Entity—an individual or group of individuals conducting business.

Application portfolio—a set of software applications used by an entity.

Weighted response—a value assigned to a response to a question.

Business strategy—the business goals, priorities, expectations, or the like of an entity.

Set—a group of zero or more (e.g., applications, questions, recommendations, etc.).

II. Overview

Generally stated, the present invention provides a method and system for analyzing the application needs of an entity. As indicated above, an entity may have an application portfolio that comprises numerous applications. The present invention provides a way to align, transform, and/or optimize the portfolio. Specifically, the method and system of the present invention present a set of questions and weighted responses relating to the entity's applications. The questions and weighted responses are based upon the entity's business strategy (e.g., including the entity's information technology (IT) strategy). The weighted responses are formulated by assigning a value to each possible response to the set of questions. The entity's responses to the questions are analyzed, and a set of recommendations regarding the application portfolio are made. Such recommendations could be to add a new application(s), to modify or delete an existing application(s), or to switch between applications.

III. Computer System

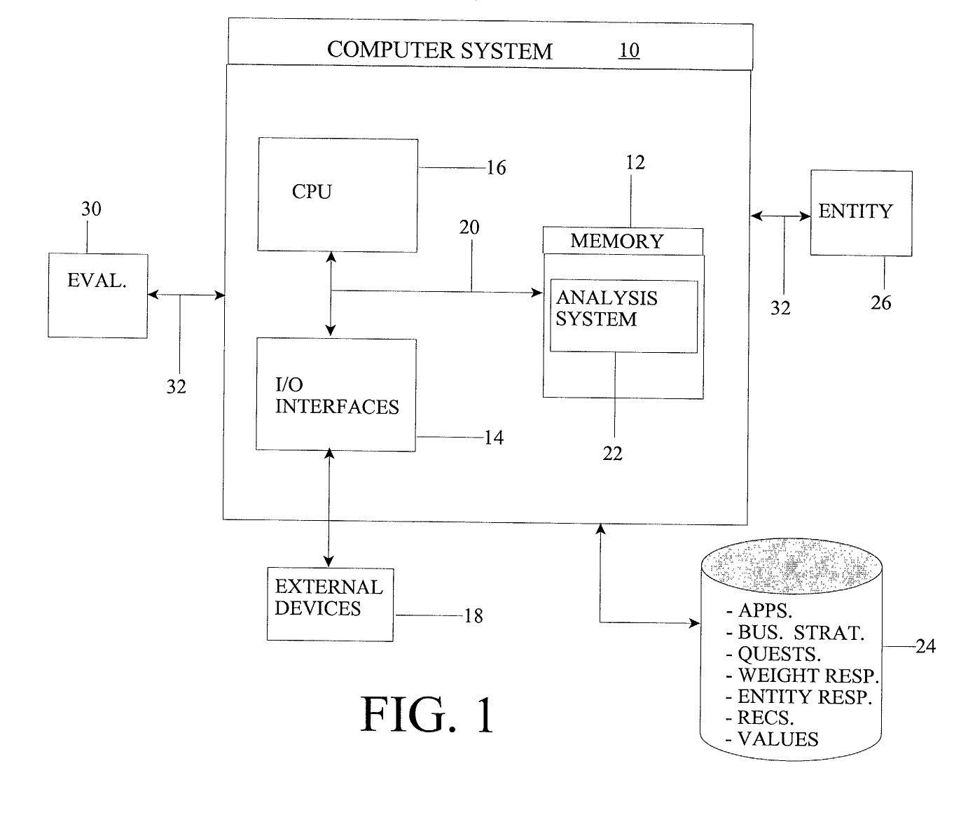

Referring now to FIG. 1, a computer/server system 10 that includes the analysis system 22 of the present invention is shown. The computer system 10 generally comprises memory 12, input/output interfaces 14, a central processing unit (CPU) 16, external devices/resources 18, bus 20, and database 24. Memory 12 may comprise any known type of data storage and/or transmission media, including magnetic media, optical media, random access memory (RAM), readonly memory (ROM), a data cache, a data object, etc. Moreover, memory 12 may reside at a single physical location, comprising one or more types of data storage, or be distributed across a plurality of physical systems in various forms. CPU 16 may likewise comprise a single processing unit, or be distributed across one or more processing units in one or more locations, e.g., on a client and server.

I/O interfaces 14 may comprise any system for exchanging information from an external source. External devices 18 may comprise any known type of external device, including a CRT, LED screen, hand-held device, keyboard, mouse, voice recognition system, speech output system, printer, facsimile, pager, personal digital assistant, cellular phone, web phone, etc. Bus 20 provides a communication link between each of the components in the computer system 10 and likewise may comprise any known type of transmission link, including electrical, optical, wireless, etc. In addition, although not shown, additional components, such as cache memory, communication systems, system software, etc., may be incorporated into computer system 10.

Stored in memory 12 is analysis system 22 (shown in FIG. 1 as a software product). Analysis system 22 will be described in more detail below but generally comprises a method and system for analyzing the application needs of entity 26. Database 24 provides storage for information 30 necessary to carry out the present invention. Such information could include, inter alia: (1) entity's 26 business strategy; (2) entity's 26 application portfolio; (3) questions to be posed to entity 26; (4) weighted responses; and (5) entity's 26 actual responses to the questions; (6) recommendations; and (7) values corresponding to responses. Database 24 may comprise one or more storage devices, such as a magnetic disk drive or an optical disk drive. In another preferred embodiment, database 24 includes data distributed across, for example, a local area network (LAN), wide area network (WAN) or a storage area network (SAN) (not shown). Database 24 may also be configured in such a way that one of ordinary skill in the art may interpret it to include one or more databases.

As will be described in further detail below, computer system 10 queries entity 26 with a set of questions for the applications in entity's 26 application portfolio. The queried entity 26 will answer the questions with a set of responses. Each possible response is weighted with an assigned value. Entity's 26 response will then be analyzed to determine its application needs and whether any changes should be made to its application portfolio.

Communication with computer system 10 by entity 26 or an evaluator 30 occurs via communication links 32. Communications links 32 can include a direct terminal connected to the computer system 10, or a remote workstation in a client-server environment. In the case of the latter, the client and server may be connected via the Internet, wide area networks (WAN), local area networks (LAN) or other private networks. The server and client may utilize conventional token ring connectivity, Ethernet, or other conventional communications standards. Where the client is connected to the system server via the Internet, connectivity could be provided by conventional TCP/IP sockets-based protocol. In this instance, the client would utilize an Internet service provider outside the system to establish connectivity to the system server within the system.

It is understood that the present invention can be realized in hardware, software, or a combination of hardware and software. As indicated above, the computer system 10 according to the present invention can be realized in a centralized fashion in a single computerized workstation, or in a distributed fashion where different elements are spread across several interconnected computer systems (e.g., a network). Any kind of computer system—or other apparatus adapted for carrying out the methods described herein—is suited. A typical combination of hardware and software could be a general purpose computer system with a computer program that, when loaded and executed, controls the computer system 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

IV. Analysis System

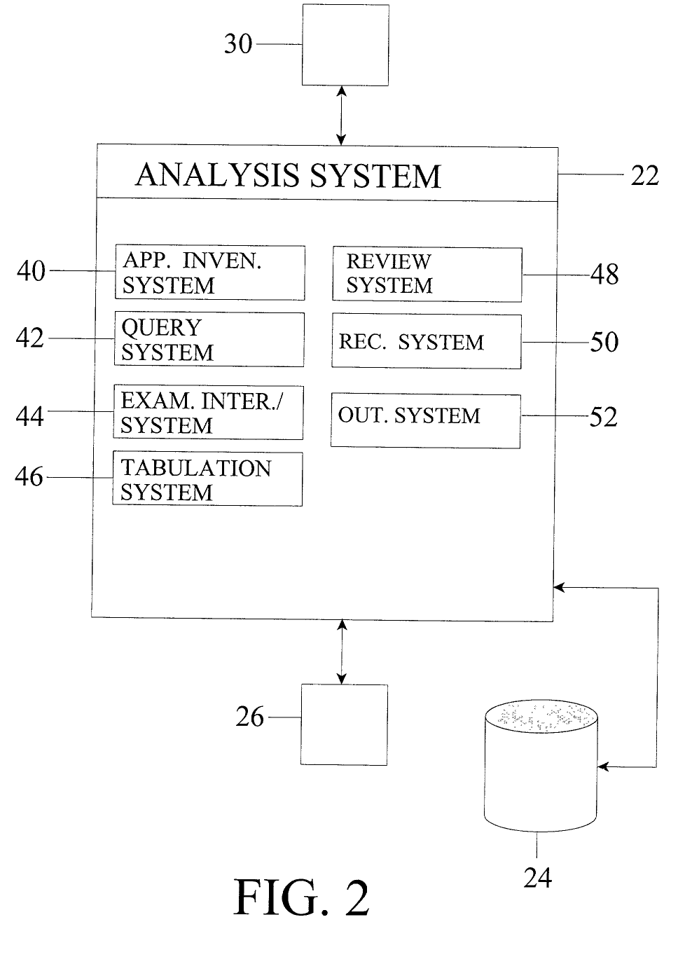

Referring now to FIG. 2, analysis system 22 is shown in greater detail. As indicate above, analysis system 22 analyzes the application needs of entity 26. The analysis is conducted by examining entity's 26 business strategy and application portfolio. Based on the business strategy, a set of questions and weighted responses are formulated for the applications. Entity's 26 responses to each question are analyzed to determine entity's 26 applications needs.

Before the analysis can be conducted, information pertaining to entity's 26 application portfolio and business strategy must be provided. Typically, this information provided directly by entity 26 (although it could be provided by any other party) and can be in any format/framework. For example, the information could be provided verbally, as a hard copy, or in an electronic format. In the case of the latter, the application information and business strategy is preferably stored in database 24.

Once the application portfolio has been provided, application inventory system 40 will inventory entity's 26 applications. Specifically, application inventory system 40 will examine the application portfolio, and group the applications by business process. As indicated above, each entity could have several business processes and associated sub-processes (e.g., banking: on-line banking, check clearing, etc.), each of which uses numerous applications. Application inventory system 40 will inventory and group the applications according to such business processes.

After inventorying, query system 42 will provide/obtain questions and weighted responses relating to each application. The questions and weighted response are formulated based upon entity's business strategy and are tailored to assess entity's 26 applications needs. For example, entity's 26 business strategy could resemble the following:

Highest business priorities are:

(1) maximize world wide web sales;

(2) provide customer access to data; and

(3) comply with data privacy regulations.

Based on this exemplary business strategy, one possible question could be. “On what platform does the application reside?” (examples of other questions will be further illustrated below). Preferably the formulated questions fall under four topics: (1) topology; (2) demographics; (3) support; and (4) standards. Topology questions investigate the computing infrastructure (e.g., software, hardware) surrounding an application. Demographics questions assess the business value of an application to entity 26. Support questions investigate the type of technical support an application receives. Standards questions investigate any standards (internal or external) that may apply to an application. However, it should be understood that since each analysis is preferably customized to a particular entity based on their business strategy, these topics are intended to be illustrative only.

In a first preferred embodiment, the questions are formulated by evaluator 30, based on an examination of entity's 26 business strategy, and stored in database 24. Thus, query system 42 could merely retrieve the questions and weighted responses from database 24. It should be understood that in this case, evaluator 30 could be an individual, group of individuals, or an expert system that can automatically generate questions and weighted responses. Moreover, access to the business strategy by evaluator 30 can be made by accessing analysis system 22, as indicated above in conjunction with FIG. 1, and retrieving the business strategy from database 24. Alternatively, evaluator 30 could obtain a hard copy of the business strategy directly from entity 26.

Weighted responses are preferably formulated by evaluator 30 by assigning a value to each possible response to the sets of questions based on the business strategy. For the example question above, there could be five possible responses:

(1) application “A” is non compliant;

(2) application “A” compliance is in process with no target;

(3) application “A” compliance is in process with a target;

(4) application “A” is compliant but not tested; and

(5) application “A” is compliant and tested.

Since compliance was indicated as a high priority in the business strategy, each possible response could be assigned a value. For example, the values could be as follows:

(1) non compliant—1;

(2) in process with no target—2;

(3) in process with a target—3;

(4) compliant but not tested—4; and

(5) compliant and tested—5.

It should be understood that the values assigned to each response shown herein are for illustrative purposes only and are not intended to be limiting. In addition, it should be appreciated that although evaluator 30 was described as formulating the questions and weighted responses, query system 42 could be an internal expert system that formulates the questions and weighted response based on examination of the application portfolio and business strategy information stored in database 24.

Once a set of questions and weighted responses have been developed for each of entity's 26 applications, the questions are presented to entity 26 by examination system 44. Preferably, examination system 44 is an interface (e.g., a world wide web browser) at which entity 26 can view and respond to the formulated questions. However, it should be understood that the formulated questions could be transmitted electronically to entity 26 (e.g., as an electronic mail message) from examination system 44. In addition, it should be understood that although a set of questions is preferably formulated and presented for groups or subsets of applications within the application portfolio, this need not be the case. For example, a single set of questions could be formulated for all applications. Alternatively, different sets of questions could be formulated for each separate application. The manner in which sets of questions correspond to applications could depend on the particular application portfolio being analyzed.

Entity 26 will respond to each question, and the values that were assigned to each response will be tabulated by tabulation system 46. As indicated above, each possible response to the sets of questions is weighted with an assigned value (i.e., a value was assigned thereto). Tabulation system 46 will mathematically manipulate the values to provide a baseline response. For example, tabulation system 46 could sum the values of entity's 26 responses to determine the baseline response. Thus, if an entity responded to five questions for application “A,” and was awarded a total of 17 points based on the responses, the baseline response would be 17. Once the baseline response is tabulated, review system 48 will perform an analysis. In a preferred embodiment, review system 48 will compare the baseline response to predetermined values or ranges of values to make recommendations. For example, the particular questions posed to entity might correspond to the following predetermined ranges and recommendations:

(1) 0-5 points—delete application “A”;

(2) 6-10 points—modify application “A”;

(3) 11-15 points—keep the application as is; and

(4) 16-20 points—replace application “A” with application “B.”

The predetermined values and their corresponding recommendations are preferably stored in database 24 by evaluator and accessed by review system 48 upon tabulation of the baseline response.

It should be understood that the precise mathematical operation performed to obtained the baseline response and the ranges of values cited above are intended to be illustrative only. Specifically, the values could be multiplied, divided, subtracted, and/or added in any way. Moreover, it should be appreciated that tabulation need not be necessary for analyzing the entity's responses. For example, the value assigned to each entity response could be a separate baseline response upon which recommendations are made.

Once the initial analysis has been made by review system 48, further recommendations can be made by recommendation system 50. As illustrated above, the comparison of the baseline response to predetermined values can yield some initial recommendations. Recommendation system 50 can access database 24 to retrieve other related recommendations. For the example illustrated above, the entity had a baseline response of 17, which indicated that application “A” should be replaced with application “B.” However, further recommendations could be made regarding, for example, any specific installation/set-up instructions or beneficial modifications for application “B.” Preferably, these recommendations are also stored in database 24 and retrieved by recommendation system 50.

Once the analysis is complete, output system 52 presents the baseline response, recommendations, and/or any other useful information to entity 26 in a report format. The report preferably highlights the recommendations for optimizing entity's 26 applications portfolio. In addition, the report could be presented to entity 26 at an interface or could be transmitted electronically by output system 52. Preferably, the template/format used to create the report is stored in database 24 by evaluator 30 and is retrieved by output system 52.

It should be appreciated that the description of analysis system 22 is for illustrative purposes only and analysis system 22 can take many different forms. For example, review system 48 and recommendation system 50 could exist as a single system. Moreover, all information retrieved from database 24 could be retrieved by a single system. In this case, it would not be necessary for query system 42, review system 48, recommendation system 50, and output system 52 to individually access database 24.

It should be further appreciated that the embodiment of the present invention as computer hardware and/or software is only one preferred embodiment of the present invention. Specifically, the present invention could be carried out manually (in part or in whole) by an individual or group of individuals (e.g., evaluators(s)). This would require interfacing with entity 26 to obtain the business strategy and application portfolio information as well as to exchange questions and entity responses. Once the entity responses have been obtained, the evaluator(s) could manually perform the analysis and make a set of recommendations.

V. Example Matrices

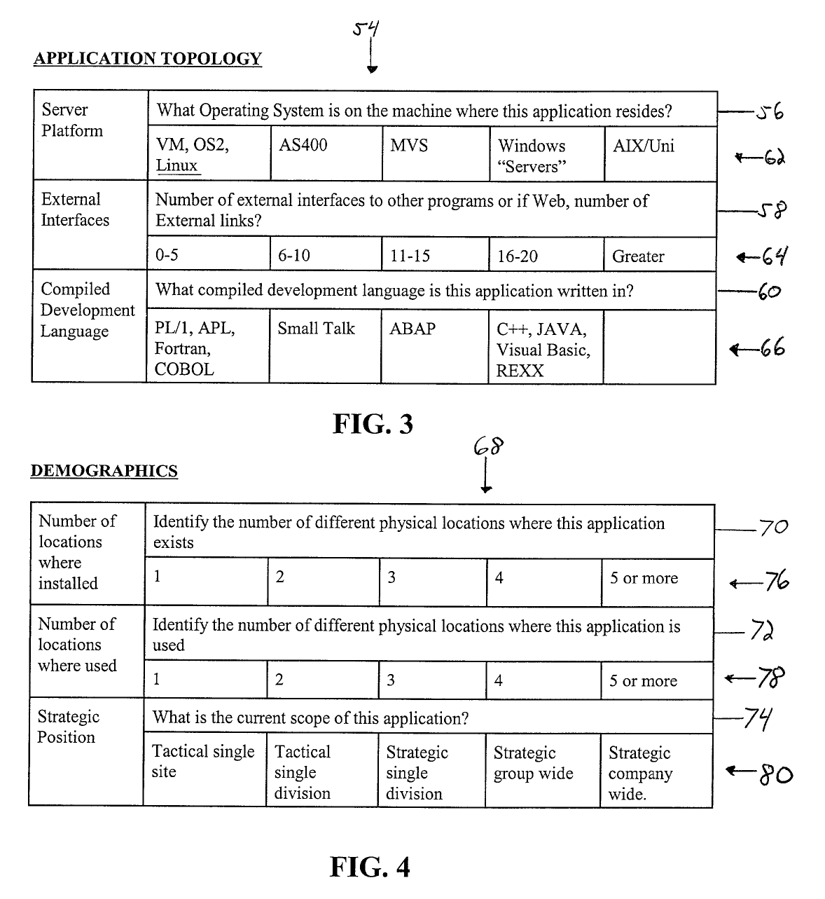

Referring now to FIGS. 3-6, illustrations of questions and possible responses are illustrated for a particular application. As described above, each application preferably has a set of questions and weighted responses formulated therefor. The set of questions, as well as how the possible responses are weighted (i.e., what values are assigned to particular possible responses), based on the entity's business strategy. FIG. 3 shows an exemplary matrix 54 of questions 56, 58, and 60 directed to investigate an entity's software and hardware topology.

Specifically, questions in matrix 54 help determine the entity's computing infrastructure. As shown, there are three questions 56, 58, and 60, each having possible responses 62, 64, and 66, respectively. First question 56 inquires about the operating system of the machine where the particular application resides. Second question 58 inquires about the quantity of external interfaces or links. Third question 60 inquires about the development language of the application.

FIG. 4 shows an exemplary matrix 68 of questions 70, 72, and 74 directed to investigate the number and/or type of users of the application. As shown, there are three questions 70, 72, and 74 each having possible responses 76, 78, and 80, respectively. First question 70 inquires about the quantity of different physical locations where the application exists. Second question 72 inquires about the quantity of different physical locations where the application is used. Third question 74 inquires about the current scope of the application.

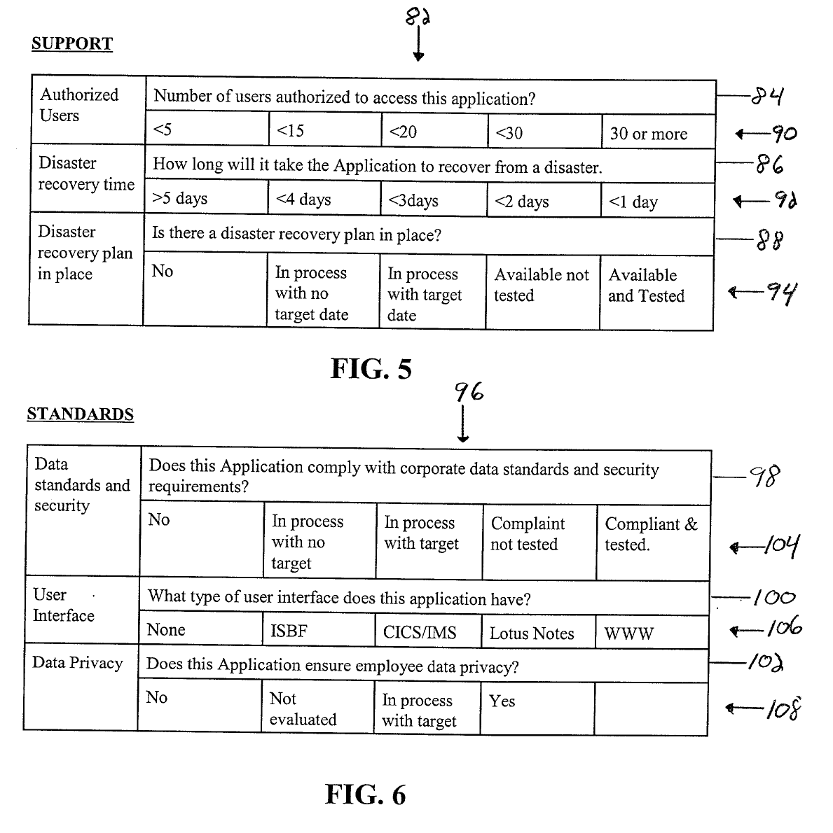

FIG. 5 shows an exemplary matrix 82 of questions 84, 86, and 88 directed to investigate the technical support given to an application. As shown, there are three questions 84, 86, and 88, each having possible responses 90, 92, and 94, respectively. First question 84 inquires about the quantity of users authorized to access the application. Second question 86 inquires about how long it would take the application to recover from a disaster. Third question 88 inquires about whether a disaster recovery plan is in place.

FIG. 6 shows an exemplary matrix 96 of questions 98, 100, and 102 directed to investigate any standards (internal or external) that may apply to the application. As shown, there are three questions 98, 100, and 102 each having possible responses 104, 106, and 108, respectively. First question 98 inquires about whether the application complies with corporate data standards and security requirements. Second question 100 inquires about what type of user interface the application has. Third question 102 inquires about whether the application ensures employee data privacy.

In each of the above matrices 54, 68, 82, and 96, the possible responses are weighted with an assigned value. Thus, as described above, an entity's responses for the particular queried application could be obtained and analyzed. Based on the analysis, a set of recommendations could be made. It should be understood that the questions and response shown in FIGS. 3-6 are for illustrative purposes only and are not intended to be exhaustive. For example, each matrix could include a different quantity of questions and responses.

VI. Methods

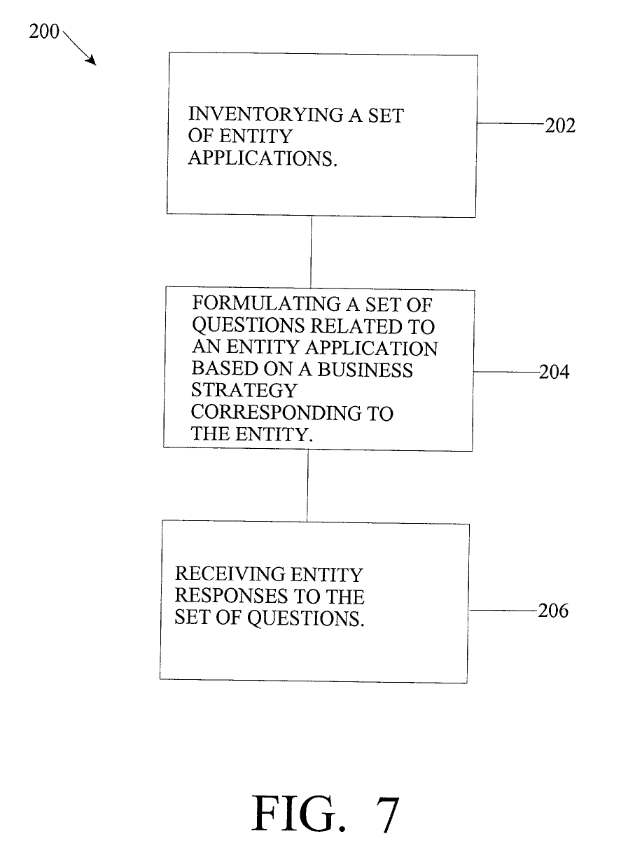

Referring now to FIG. 7, a first method 200 according to the present invention is shown. First step 202 in method 200 is to inventory a set of entity applications. Second step 204 is to formulate a set of questions related to an entity application based on a business strategy corresponding to the entity. Third step 206 is to receive entity responses to the set of questions.

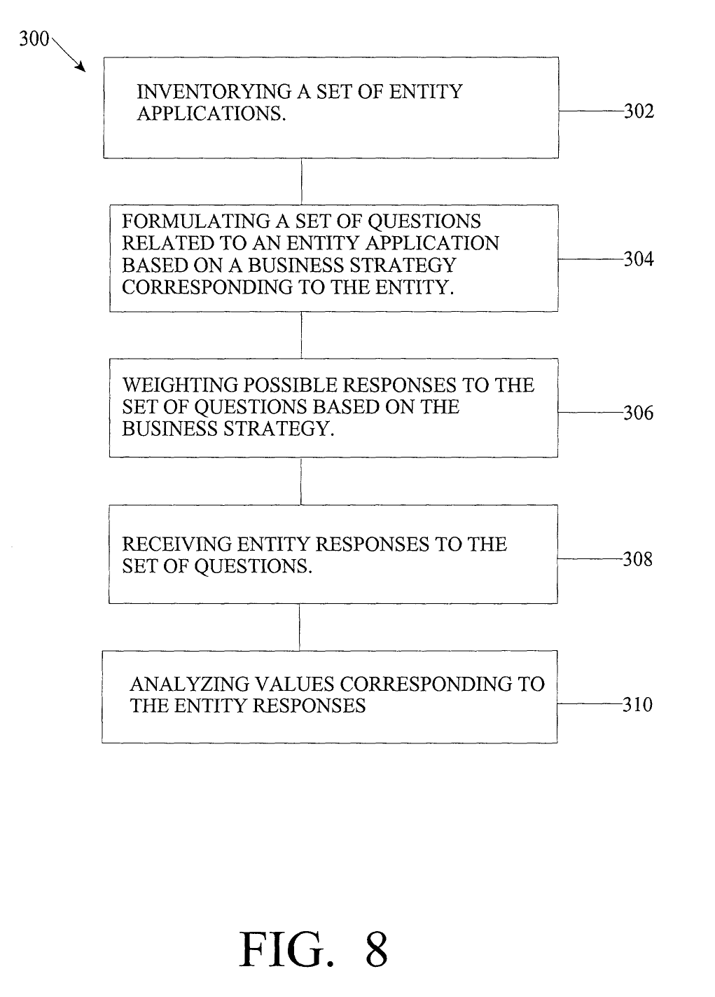

FIG. 8 depicts a second method 300 according to the present invention. First step 302 of method 300 is to inventory a set of entity applications. Second step 304 is to formulate a set of questions related to an entity application based on a business strategy corresponding to the entity. Third step 306 is to weight possible responses to the set of questions based on the business strategy. Fourth step 308 is to receive entity responses to the set of questions. Fifth step 310 of method 300 is to analyze the entity responses to make a set of recommendations.

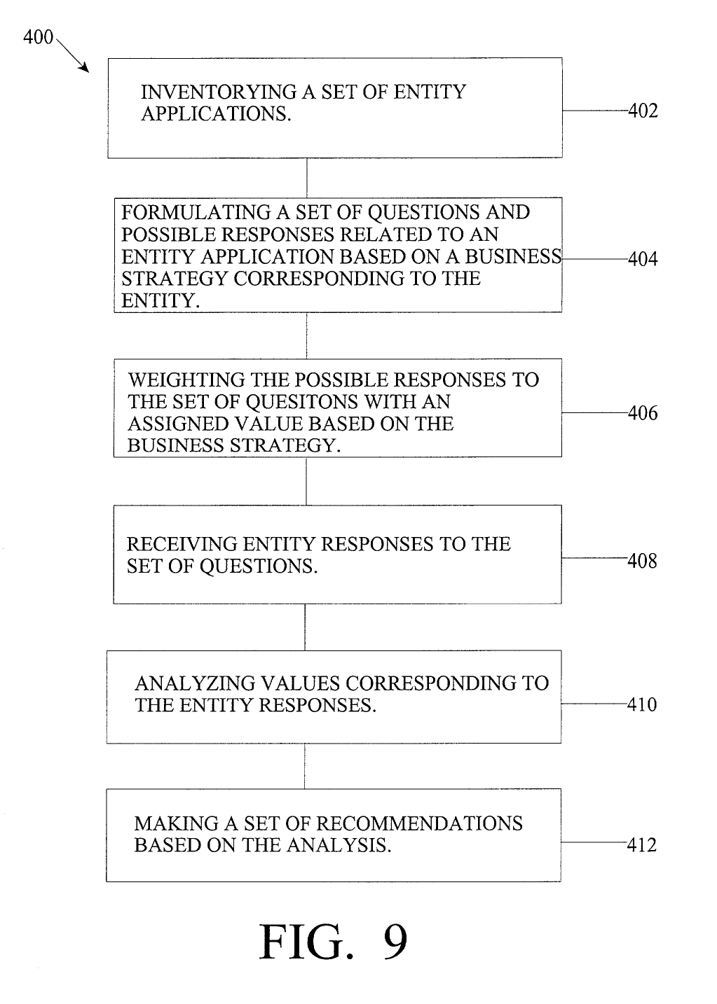

FIG. 9 depicts a third method 400 according to the present invention. First step 402 is to inventory a set of entity applications. Second step 404 is to formulate a set of questions and possible responses related to an entity application based on a business strategy corresponding to the entity. Third step 406 is to weight the possible responses for each question with an assigned value based on the business strategy. Fourth step 408 is to receive entity responses to the set of questions. Fifth step 410 is to analyze values corresponding to the entity responses. Sixth step 412 of method 400 is to make a set of recommendations based on the analysis.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for analyzing application needs of an entity, comprising the steps of:
inventorying a set of entity applications;
formulating a set of questions related to an entity application based on a business strategy corresponding to the entity; and
receiving entity responses to the set of questions.

2. The method of claim 1, further comprising the step of weighting possible responses to the set of questions based on the business strategy.

3. The method of claim 2, wherein the step weighting responses comprises the step of assigning a value for each possible response to the set of questions.

4. The method of claim 1, further comprising the step of analyzing the received responses to make a set of recommendations.

5. The method of claim 1, further comprising the step of generating a report based on the received entity responses.

6. The method of claim 1, wherein the entity applications are grouped by business process.

7. A method for analyzing application needs of an entity, comprising the steps of:
inventorying a set of entity applications;
formulating a set of questions related to an entity application based on a business strategy corresponding to the entity;
weighting possible responses to the set of questions based on the business strategy;
receiving entity responses to the set of questions; and
analyzing the entity responses to make a set of recommendations.

8. The method of claim 7, further comprising the step of generating a report based on the entity responses.

9. The method of claim 8, wherein the report includes the recommendations.

10. The method of claim 7, wherein the weighted responses are formulated by assigning a value to each possible response to the set of questions.

11. The method of claim 7, wherein the set of recommendations is made by analyzing values corresponding to the entity responses.

12. The method of claim 11, wherein analyzing values comprises comparing the values corresponding to the entity responses to a predetermined value.

13. A method for analyzing application needs of an entity, comprising the steps of:
inventorying a set of entity applications;
formulating a set of questions and possible responses related to an entity application based on a business strategy corresponding to the entity;
weighting the possible responses for each question with an assigned value based on the business strategy;
receiving entity responses to the set of questions;
analyzing values corresponding to the entity responses; and
making a set of recommendations based on the analysis.

14. The method of claim 13, wherein the set of recommendations is selected from the group consisting of: eliminating the entity application, modifying the entity application, adding a new application, or switching between applications.

15. The method of claim 13, wherein the analysis is made by comparing values corresponding to the entity responses to predetermined values.

16. A system for analyzing application needs of an entity, comprising:
an inventory system for inventorying entity applications;
a query system for providing a set of questions and weighted responses related to an entity application, wherein the set of questions and weighted responses are formulated based on a business strategy corresponding to the entity; and
a review system for analyzing entity responses to the set of questions.

17. The system of claim 16, further comprising an examination system for receiving the entity responses.

18. The system of claim 16, wherein the query system formulates the set of questions and weighted responses based on the business strategy.

19. The system of claim 16, wherein the query system retrieves the set of questions and weighted responses from a database.

20. The system of claim 16, wherein the review system compares values corresponding to the entity responses to a predetermined value.

21. The system of claim 16, further comprising a recommendation system for making recommendations based on the entity responses.

22. A system for analyzing application needs of an entity, comprising:
an inventory system for inventorying entity applications;
a query system for providing a set of questions and weighted responses related to an entity application, wherein the set of questions and weighted responses are formulated based on a business strategy corresponding to the entity;
an examination system for receiving entity responses to the set of questions;
a review system for analyzing values corresponding to the entity responses; and
a recommendation system for making a set of recommendations based on the analyzed values.

23. The system of claim 22, wherein the query system formulates the set of questions and weighted responses based on the business strategy.

24. The system of claim 22, wherein the query system retrieves the set of questions and weighted responses from a database.

25. The system of claim 22, wherein the review system compares values corresponding to the entity responses to a predetermined value.

26. A program product stored on a recordable medium for analyzing application needs of an entity, which when executed, comprises:
an inventory system for inventorying entity applications;
a query system for providing a set of questions and weighted responses related to an entity application, wherein the set of questions and weighted responses are formulated based on a business strategy corresponding to the entity; and
a review system for analyzing entity responses to the set of questions.

27. The program product of claim 26, further comprising an examination system for receiving the entity responses.

28. The program product of claim 26, wherein the query system formulates the set of questions and weighted responses based on the business strategy.

29. The program product of claim 26, wherein the review system compares values corresponding to the entity responses to a predetermined value.

30. The program product of claim 26, further comprising a recommendation system for making recommendations based on the entity responses.

31. A computer system for analyzing application needs of an entity, comprising:
a processor;
a computer system memory;
an interface; and
a software product stored on the computer system memory and executable by the processor, wherein the software product comprises:
an inventory system for inventorying entity applications;
a query system for providing a set of questions and weighted responses related to an entity application, wherein the set of questions and weighted responses are formulated based on a business strategy corresponding to the entity; and
a review system for analyzing entity responses to the set of questions.

32. The computer system of claim 31, further comprising an examination system for receiving the entity responses.

33. The computer system of claim 31, wherein the query system formulates the set of questions and weighted responses based on the business strategy.

34. The computer system of claim 31, wherein the review system compares values corresponding to the entity responses to a predetermined value.

35. The computer system of claim 31, further comprising a recommendation system for making recommendations based on the entity responses.
